(19) United States
(12) Patent Application Publication
(10) Pub. No.: US 2011/0163548 A1
(43) Pub. Date: Jul. 7, 2011

(54) Earth's natural energy

(76) Inventor: Chiu Chui Wen, Branchton (CA)

(21) Appl. No.: 12/654,811

(22) Filed: Jan. 5, 2010

(51) Int. Cl. F03B 13/08; F03B 17/04

(52) U.S. Cl. 290/54; 415/916

(57) ABSTRACT

Electrical power is produced by harnessing the natural energy from a deep well containing water or alcohol. A steel process tower having capillary characteristics is installed in the well. High pressure air enters the bottom of the well to create air bubbles rising in the well. The rising bubbles rotates a vertical helical propeller or turbine to produced the rotation movement for turning an electrical generator to produce the electrical output. Alternatively, separate sections and pressure reduction device may be provided in the tower to draw water to a water storage tower from which the water is directed to flow to a water wheel to rotate the electrical generator.

### FIELD OF THE INVENTION

This invention relates to the method and device for utilizing earth's natural energy to produce electrical power. It combines the latent energy of water pressure which can crush a submarine with air to produce the characteristics of combined water and converting it to the energy for operating an electrical generator for producing electrical output.

### BACKGROUND OF THE INVENTION

Even in thirty years ago when I was hitch-hiking on a highway, the roadway was already so polluted that I had to change my clothing in every one to two days. Nowadays, inflation is rampant due the rapid depletion of natural resources such as crude oil and coal. The White House is asking the general public to save natural energy by turning down the thermostat in all commercial buildings to a comfortable lower level. The demand of crude oil and coal is ever increasing due to the advance in economy for supplying the requirements in transportation, power generation, and fertilizer industries. People ignore the warning from the scientists and the environmentalists about the worldwide pollution problem. It is a long term serious environmental problem in the production of toxic carbon dioxide and the resulting global warming. When one looks at the numerous automobiles traveling at night on the highway, which emit an enormous amount of toxic carbon dioxide, one can not stop to think that people are burning the sky. Can such blatant disregard of the environment be allowed to continue?

It is now evident that the disregard of the environment has caused the rapid melting of the north pole, and increase in hurricane, and flooding all over the world. Five years ago people regarded environmentalist's warning as nuisance. Now natural disasters due to worldwide pollution are actually happening faster than the forecast by the environmentalists. This year, 1500 concerned environmentalists as well as more than 120 world leaders have met in Copenhagen in Denmark under the United Nations to discuss a solution to the pollution problem, which can meet the economic development for 630 million population around the globe. The present invention provides a viable solution to such problem.

(1) The resources require for carrying out the invention are (a) a fixed amount of water; (b) high pressure air; and (c) alcohol or similar substance.
(2) Does not require nuclear scientists to protect and treat waste material.
(3) It replaces hydro power generation by water dams.
(4) It is low cost in building the facility and technician and engineers in all 193 countries in the world is capable of creating such facility.
(5) It does not emits any smoke.

### SUMMARY OF THE INVENTION

Global warming has brought on enormous amount of problems to the environment; however, industry must be developed so as to provide jobs for people to make a living; and the increase in industrial development inherently would result in the increase in the demand of electrical energy that is normally produced efficiently with oil, coal and nuclear power which all emit a large amount of harmful carbon dioxide into the atmosphere. The amount of electrical energy obtained from alternative environmentally friendly wind turbines, solar panels, and hydro power are largely not as efficient as that generated with oil, coal and nuclear powder. In the environment conference recently held in Copenhagen, it had concluded that job opportunity creation in the society was closely related to the amount of carbon dioxide emission into the atmosphere. The environment conference targeted the achievement of 100% elimination of world wide carbon dioxide emission by year 2020 depending on the willingness of the members in inventing a large amount of money from now until 2020 in order to meet such target. Such inconclusive target really is not effective in resolving the harmful emission problem. It has been estimated that by year 2050, a large proportion of the world population could have an average age of over 100 years old, and yet the world would still be discussing the reduction of carbon dioxide emission.

I hope with financial investment, technology can be quickly found to utilize clean natural resources and means to produce electrical energy such that countries, rich and poor, may instigate such technology for cleanly producing electrical energy without harming the environment. This is the object of the present invention.

(1) The natural resources for the present invention are air obtained from the atmosphere and water supplied by a deep well. Water is continuously recycled in the process.

(2) An air compressor is required in the process.

(3) An intermittently operated pump is provided which is controlled to pump a predetermined amount of air intermittently through the water.

(4) The present invention can quickly bring the world into a fairy tell story.

(5) Utilizing a steel pipe or plastic pipe having interior capillary characteristic as shown in the drawings.

(6) The water in the well may be replace with alcohol which may be vaporized with a controlled amount heat to provide the energy to operate the generator for producing electrical energy.

### BRIEF DESCRIPTION OF THE DRAWINGS AND DETAILED DESCRIPTION OF THE PREFERRED EMBODIMENTS

FIG. 1 shows a partial sectional and partially cut front elevation view of the well for generating the electrical energy according to the present invention. The well 1 may be a deep well which naturally exerts an upward water pressure in the water, or alternatively a shallow well in which external pressure is provided to force the water to rise upward therein. The electrical energy generating tower 2 has an internal construction as shown in the cut view. The tower 2 is immersed in the water 3 in the well. The tower 2 has a cylindrical side wall 4. A plurality of downwardly slanting reverse baffle rings 5 are located on the entire internal side wall of the tower 2. Detailed construction of the reverse baffle rings 5 is shown in FIG. 3 below. A reverse flow baffle valve 6 is located at the bottom of the tower 2. An elongated rotatable shaft 7 is located in a vertical manner in the tower 2, and an elongated helical propeller 8 is mounted on and surrounding the shaft 7. The propeller 8 is rotatable by the water rising in the tower 2. An intermittent pump 9 is located in the upper portion of the well 1. The intermittent pump 9 operates to provide intermittent air pressure for the reverse baffle rings 5 through a air pressure storage 13. The amount of air rising through the air tube 15 is controlled by a controller 10 to operate in a selected intermittent intervals. A plurality of inlet openings 11 are formed in the side wall of the well. Additional water may be injected into the well through the inlet openings 11 or they may be blocked to retain the volume of the water in the well. An electrical generator 12 is coupled to the shaft 7 and is rotatable by the latter to provide the electrical output of the device. The shaft 7 is rotatably mounted to a support 14 which includes ducts to facilitate water under pressure to rise within the tower 2. High pressure air is conducted from the air pressure storage 13 through air tube 15 to the bottom of the tower 2. A heater 10′ is provided for heating the pressure air conducted through the air tube 15 if required. Water brought to the top portion of the tower 2 is recycled to the bottom of the well through a recycle valve 16. An inverted U-shaped 16′ tube is mounted on a partition wall between the water 3 and an upper air chamber of the well 2 and it is operable to release the pressure build-up in the upper portion of the well by releasing air from the upper air chamber through a releasing valve 11′.

As shown in the enlarged isolated partial sectional elevation view of the bottom portion of the well in FIG. 2, the side wall 1′, the water 3′, the side wall 4′, the downwardly slanting reverse baffle rings 5′, as shown in the enlarged view in FIG. 3, and the reverse flow baffle valve 6′ of the tower are more clearly illustrated. The enlarged isolated view also shows the rotatable shaft 7′, and the helical propeller 8′ mounted on the rotatable shaft 7′. The high pressure air conducting tube 15′ includes the characteristics of capillary tubes internally. The water in the well is inputted to the tower through a lower opening 17 to the water inlet 19 at the bottom of the tower and through the reverse flow baffle valve 6′. An air inlet 18 is located below the propeller. The air inlet 18 will automatically open to allow the high pressure air to carry the water in the tower upward to cause the propeller to rotate. Alternatively, the water in the well may be replaced with alcohol.

In the enlarged isolated partial sectional elevation view shown in FIG. 3, it shows the location of the capillary tube 15′ between the sloping wall of the reverse baffle rings 5′ and the side wall 4′ of the tower. Air pressure in the capillary tube 15′ will be increased to counter the reverse flow of the water in the tower and the pressure will be reduced to facilitate the upward rise of the water.

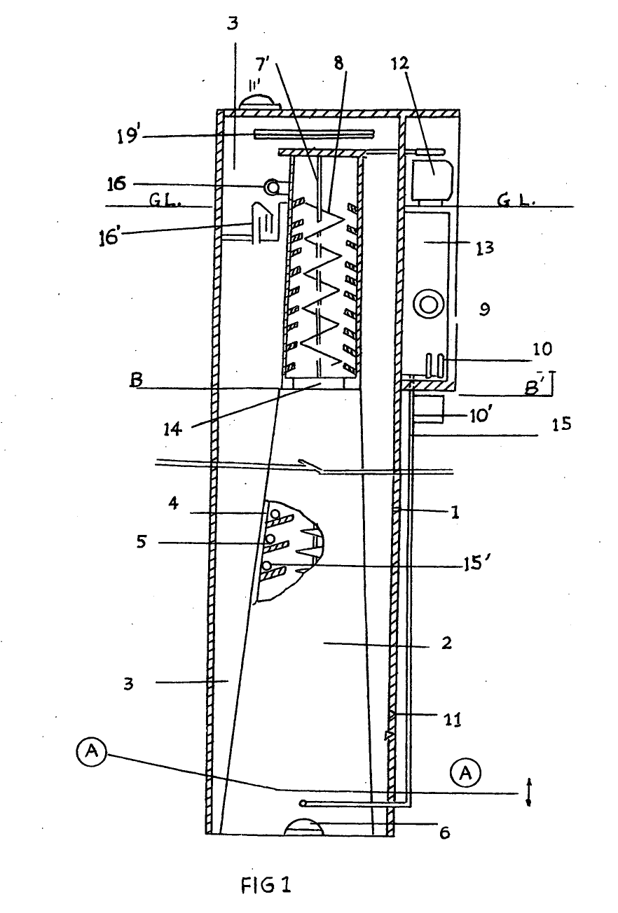

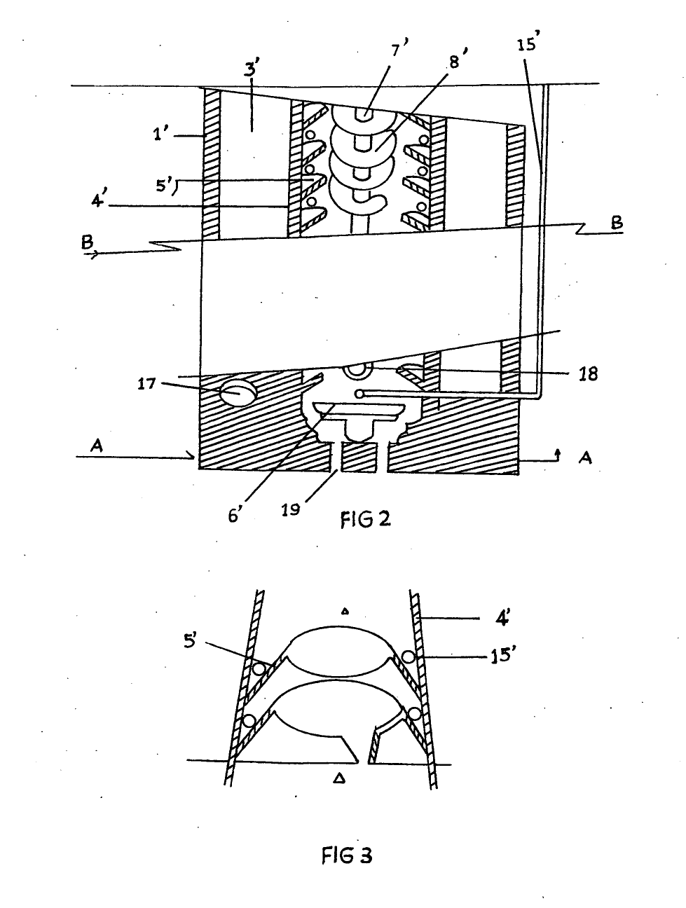

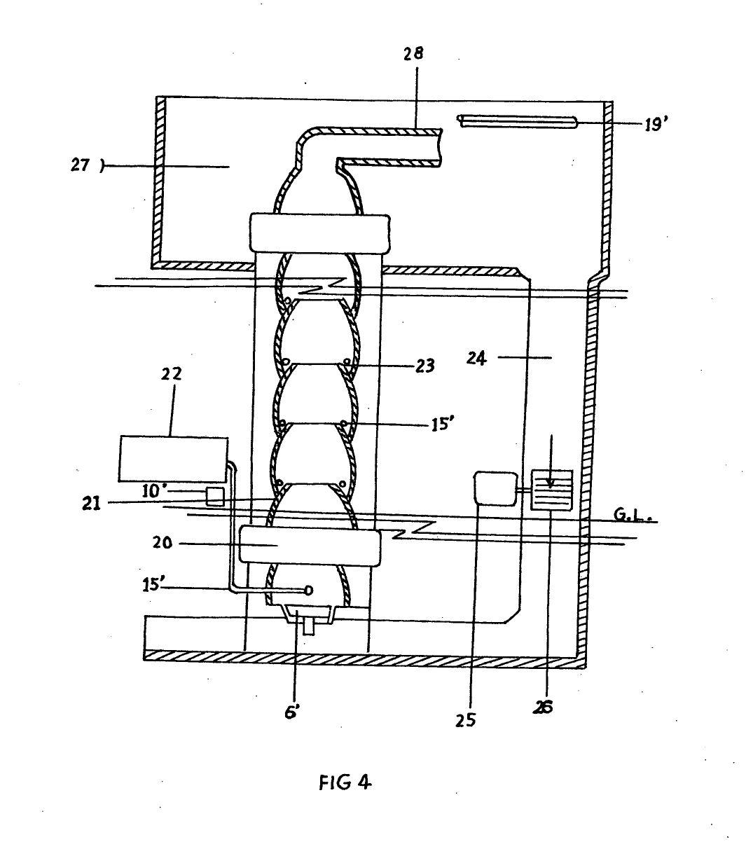

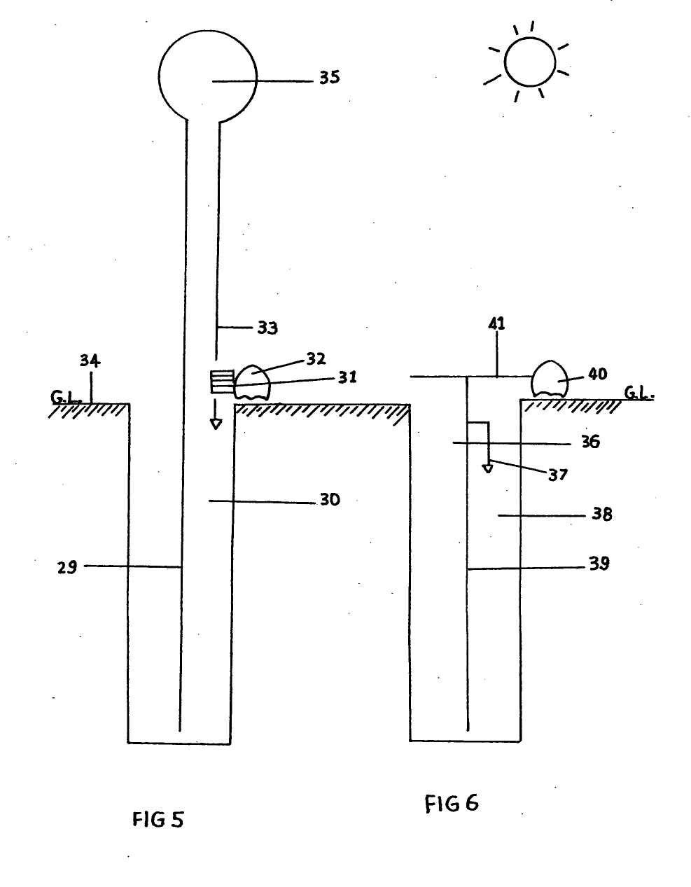

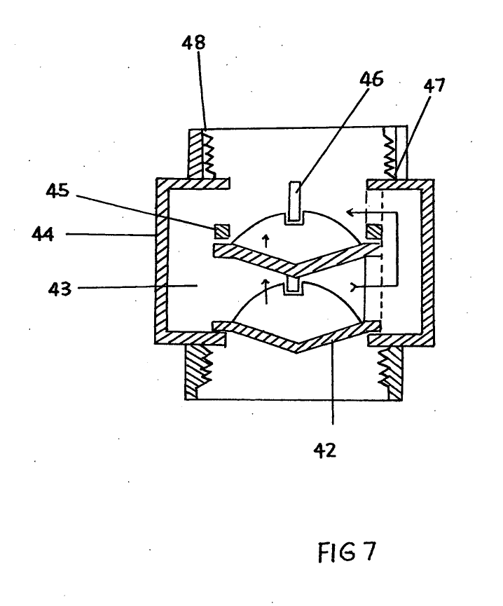

FIG. 4 shows the high tower system in a second embodiment of the present invention which operates in a similar principle as the embodiment above shown in FIG. 1. In this embodiment pressure air is injected into the tall process tower in the same manner as described in the above embodiment by either (a) turning the helical propeller with the rising water or (b) conveying the water to a water storage pool located at a high elevation location. Water from the storage pool in the high elevation location will then flow downwards to rotate a water wheel to turn the generator for generating electrical power. A plurality of such relatively small diameter process towers may be provided with relatively low cost. As shown, in FIG. 4, high pressure air is injected into the tower through inlet openings 15′. A pressure reducer 20 as more clearly shown in FIG. 7 is provided at the lower portion of the tower. The joints 21 between the egg-shell shaped reverse baffle capillary tube 23 is more clearly shown. A plurality, up to thousands of such reverse baffle capillary tubes, may be provided to deliver the water to the water storage pool 27 located at the high elevation location. High pressure air is stored in a pressure air tank 22 for supplying the high pressure air to the system. Water 24 in the water storage pool 27 flows through the outlet duct to rotate the electric generator 25 by rotating the water wheel 26 located in the outlet duct. Water from the tower flows into the water storage pool 27 through the outlet tube 28.

FIG. 5 is a schematic diagram showing the use of thousands of capillary tube of the first embodiment to cause water 30 in a well 29 to rise first to the ground level G.L. and subsequently to a water storage tank 35 located at a high elevation location. The force of the downward flowing water from the water storage tank 35 rotates the water wheel 31 to turn the generator 32 to provide the electric power output. Alcohol may be alternatively provided in the well 29 instead of water to provide a high percentage power output.

A further embodiment is shown in FIG. 6 which operates in the same principle as the embodiment shown in FIG. 5. In this embodiment, water 38 in the water well is brought upward with the capillary tube for rotating the vertical shaft 39 to rotate the generator for providing power output. Water is recycled to the well through recycle tube 37. A cover 41 is provided over the top of the well.

The construction of the pressure reducing valve 20 in FIG. 4 is shown in an enlarged isolated view in FIG. 7. The valve includes a diaphragm 42 located transversely across the lower portion of the tower. The upward rising water will push the diaphragm to move upwards until it butts against the abutment 45. Thus, the rising water is forced to change direct 43 around the diaphragm assembly so as to reduce the force of the rising water. The valve 20 has an enclosure 44. A track 46 allows the diaphragm to move up and down. The valve 20 is mounted to the capillary tube tower with threaded coupling 47.

What is claimed is:

1. A method of generating electric power comprising,
injecting high pressure air to a bottom of a water tube located in a deep well, the water tube having a capillary characteristics facilitating air bubbles created by said high pressure air to rising upwards of the water tube through a control valve, said air bubbles rising with an impact force to the upper opening of the water tube,
regulating the size of the air bubbles and the intermittent period between bubbles through said control valve,
rotating a vertical shaft with said impact force of said air bubbles with a helical propeller mounted on said vertical shaft,
coupling said vertical shaft to an electric generator for rotating said generator to provide an electric output,
utilizing said water tube to deliver water to a water tower or collection pool located at a high elevation,
releasing water from said water tower or collection pool to flow downward to rotate a water wheel coupled to said electric generator for providing said electric power output,
recycling water after cooling from the system back to the deep well.

2. A method according to claim 1 wherein a fluid is used in the deep well.

3. A method according to claim 1 wherein bottom water pressure is utilized for generating the electric power output.

4. A method according to claim 1 wherein said water tube has capillary characteristics for causing water to rise therein similar to air bubbles rising in water.

5. A method according to claim 1 wherein high pressure air is provided for forcing water to rise up the water tube in a capillary characteristic.

6. A method according to claim 1 wherein a helical propeller is mounted on the rotatable vertical shaft located in the water tube to provide the rotational movement.

7. A method according to claim 1 including injecting high pressure air in said water tube having capillary characteristic for forcing said water to rise to a much higher elevation.

8. A method according to claim 1 including a reverse flow baffle valve to prevent water from flow out of the bottom of the tower.

9. A method according to claim 1 including a control valve movable up and down relative to the water tower.

10. A method according to claim 1 wherein said well is filled with alcohol, and said alcohol is subject to expansion and contraction due to heat and cold to provide an impact force for rotating said generator for providing said electric power output.

11. A method according to claim 1 wherein said capillary tube characteristic forms the water tower for generating the electric power output.

12. A method according to claim 1 including several pressure reducing valves to create the power for forcing water to rise in the tower.

13. A method according to claim 1 wherein said capillary tube includes a plurality of egg shell shaped sections joined together.

14. A method according to claim 1 including a U-shaped pressure reducing tube provided at an output port of said system.

15. A method according to claim 1 including providing a bell shaped reverse baffle to reduce the reverse pressure towards the bottom direction located within the capillary tube.

16. A method according to claim 1 wherein said air bubbles provides a rising force cooperating with the water to provide the force for generating the electric power output.

17. A method according to claim 1 including an air compressor, a diaphragm pressure reducing valve, a cooling device and a heating device provided therein.

18. A method according to claim 1 wherein alcohol is provided in the well.

19. A method according to claim 1 including injecting additional high pressure air around the side wall of a plurality of egg shell shaped reverse baffle sections in an intermittent manner to force water to rise up said water tube.
